(19) United States
(12) Patent Application Publication
(10) Pub. No.: US 2024/0112024 A1
(43) Pub. Date: Apr. 4, 2024

(54) METHOD AND SYSTEM OF TRAINING SPIKING NEURAL NETWORK BASED CONVERSION AWARE TRAINING

(71) Applicant: Korea University Research and Business Foundation, Seoul (KR)

(72) Inventors: Jongsun PARK, Seoul (KR); Dongwoo LEW, Seoul (KR); Kyung Chul LEE, Seoul (KR)

(73) Assignee: Korea University Research and Business Foundation, Seoul (KR)

(21) Appl. No.: 18/449,188

(22) Filed: Aug. 14, 2023

(30) Foreign Application Priority Data
Sep. 23, 2022 (KR) 10-2022-0121032
Mar. 8, 2023 (KR) 10-2023-0030377

(51) Int. Cl. G06N 3/08

(52) U.S. Cl. CPC G06N 3/08

(57) ABSTRACT

Disclosed are a spiking neural network training method based the conversion aware training and a system thereof. The spiking neural network training method includes an ANN generation operation of generating an analog artificial neural network (ANN) model and inputting variable data, a conversion aware training operation of simulating a spiking neural network (SNN) model by using one or more activation functions with respect to the analog ANN model, and an SNN generation operation of generating the SNN model by correcting parameters and weights of layers based on a result of the simulation.

### CROSS-REFERENCE TO RELATED APPLICATIONS

This application claims priority under 35 U.S.C. § 119 to Korean Patent Application No. 10-2022-0121032 filed on Sep. 23, 2022 and Korean Patent Application No. 10-2023-0030377 filed on Mar. 8, 2023, in the Korean Intellectual Property Office, the disclosures of which are incorporated by reference herein in their entireties.

### BACKGROUND

Embodiments of the present disclosure described herein relate to a method and system for training a spiking neural network based on a conversion aware training model.

Neuromorphic technology is a technology for imitating the human neural structure in hardware, and has been proposed to overcome limitations of existing computing architectures that have very low efficiency and high power consumption compared to humans in performing cognitive processing functions. Therefore, the neuromorphic technology for driving an edge device with limited power and battery with low power/low energy is attracting attention.

A typical example of the neuromorphic technology is a spiking neural network (SNN). The SNN is a neural network designed to imitate the characteristics of the human brain, which has a neuron-synapse structure, and synapses connecting neurons transfer information in spike-type electrical signals. This SNN processes information based on the time difference between transmission of spike signals. In this case, the SNN transfers information with a binary spike signal, and transfers the information in the form of a set of ‘0’ or ‘ 1 ’ binary spikes. The signals are transferred to neurons through neurons in the SNN, and whether or not spikes occur is determined by differential equations representing various biological processes. In detail, when a spike arrives at an input of a neuron, the input spike is decoded and calculated with a synaptic weight, and the result is accumulated on the membrane potential of the neuron. In this case, when the accumulated membrane potential value has a value greater than or equal to a threshold value, the neuron generates an output spike, and the spike is transferred to the next neuron. In this process, the membrane potential of the neuron that generates the spike is initialized to ‘0’.

As such, since the operation of the SNN operates only when a spike occurs, low-power hardware may be implemented.

### SUMMARY

Embodiments of the present disclosure provide a spiking neural network training method and system that minimizes data loss occurring during conversion of ANN training data into SNN training data.

In addition, embodiments of the present disclosure provide a spiking neural network training method and system to which an ANN training model similar to the SNN training model is applied.

According to an embodiment of the present disclosure, an embodiment spiking neural network training method based the conversion aware training includes an ANN generation operation of generating an analog artificial neural network (ANN) model and inputting variable data, a conversion aware training operation of simulating a spiking neural network (SNN) model by using one or more activation functions with respect to the analog ANN model, and an SNN generation operation of generating the SNN model by correcting parameters and weights of layers based on a result of the simulation.

In addition, according to an embodiment of the present disclosure, a spiking neural network training system based a conversion aware training includes an ANN generator that generates an analog artificial neural network (ANN) model and to input variable data, a conversion aware training unit that simulates a spiking neural network (SNN) model by using one or more activation functions with respect to the analog ANN model, and an SNN generator that generates the SNN model by correcting parameters and weights of layers based on a result of the simulation.

### BRIEF DESCRIPTION OF THE FIGURES

The above and other objects and features of the present disclosure will become apparent by describing in detail embodiments thereof with reference to the accompanying drawings.

FIG. 1 is a diagram illustrating a conventional ANN-to-SNN conversion technique.

FIG. 2 is a flowchart of a spiking neural network training method based on a conversion aware training, according to an embodiment of the present disclosure.

FIG. 3 is a flowchart of a conversion aware training operation, according to an embodiment of the present disclosure.

FIG. 4 is a diagram schematically illustrating a method for training a spiking neural network based on a conversion aware training according to an embodiment of the present disclosure.

FIGS. 5A to 5C are simulation result graphs associated with a spiking neural network training method based on a conversion aware training, according to an embodiment of the present disclosure.

FIG. 6 is a configuration diagram of a spiking neural network training system based on a conversion aware training, according to an embodiment of the present disclosure.

FIG. 7 is a block diagram of a processing device to which a spiking neural network training system based on a conversion aware training according to an embodiment of the present disclosure is applied.

### DETAILED DESCRIPTION

Hereinafter, embodiments of the present disclosure will be described with reference to the accompanying drawings in order to describe the technical idea of the present disclosure in detail to the extent that those skilled in the art can easily carry out it. technique.

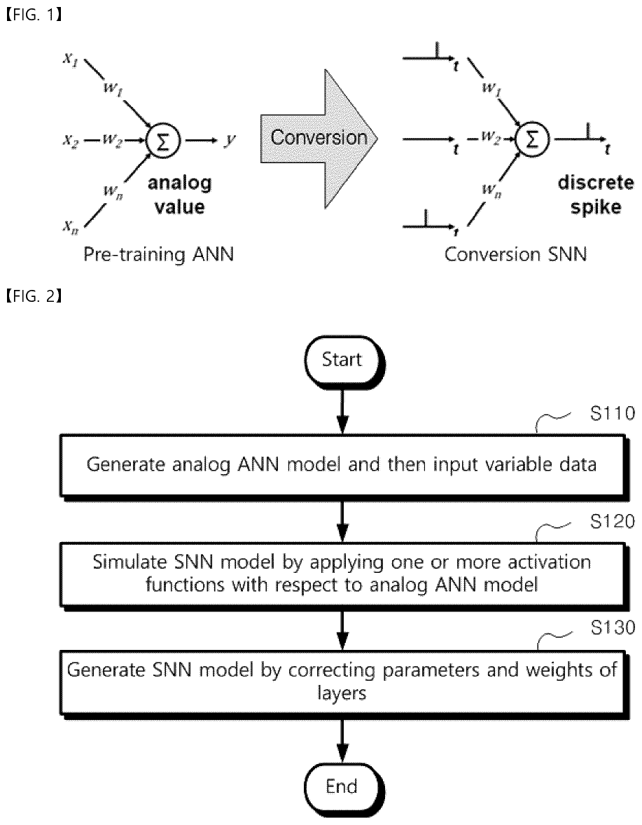

FIG. 1 is a diagram illustrating a conventional ANN-to-SNN conversion technique.

As illustrated in FIG. 1, to implement a high-performance SNN, after performing pre-training by applying back propagation training to a general analog artificial neural network (ANN), the ANN is converted into the SNN. This technique is performed because the SNN and the ANN data representation methods are different, so appropriate processing is required. That is, the technique is devised because it is difficult to apply back propagation training, which is a training method of the high-performance ANN, to the SNN. In detail, the technique is a conversion technique that implements the ANN before running the SNN, obtains updated weights through back propagation training, and applies the weights to the SNN.

The general ANN-to-SNN conversion technique has higher accuracy than data trained only by SNN, but has a problem that data loss occurs while the ANN data having an analog value is converted into discrete spikes that occur at a specific time. To minimize such data loss, a method is used to train ANNs and SNNs separately, compare the result values of the two networks, and normalize the weights or adjust the parameters of the neural network layer based on the comparison result. However, this method has a problem of increasing the burden on hardware driving, and thus an energy-efficient ANN-to-SNN conversion technique is required.

FIG. 2 is a flowchart of a spiking neural network training method based on a conversion aware training, according to an embodiment of the present disclosure.

Referring to FIG. 2, the spiking neural network training method based on a conversion aware training according to the present disclosure may include an ANN generation operation of generating an analog artificial neural network (ANN) model and inputting variable data (S110), a conversion aware training operation of simulating a spiking neural network (SNN) model by applying one or more activation functions with respect to the analog ANN model (S120), and an SNN generation operation of generating the SNN model by correcting parameters and weights of layers based on a result of the simulation (S130).

In this case, the analog artificial neural network (ANN) model may be a Deep Neural Network (DNN), a Convolution Neural Network (CNN), a Recurrent Neural Network (RNN), etc., but is not limited thereto, and is an artificial intelligence neural network excluding a Spiking Neural Network (SNN) model.

In the conversion aware training operation (S120), the activation function may be used for one or more layers of the ANN model. In this case, the activation function may include at least one of a ReLU function, a Clip function, and a Time to First Spike (TTFS) function, but is not limited thereto, and may be a function enabling SNN simulation.

In this case, the activation function is a function that serves to transfer a signal to a neuron in another layer by converting the result value of the previous layer, and may improve the complexity of the ANN model. The ReLU function and the Clip function are well-known activation functions, and may be expressed by the following equations.

$$ReLU ( x ) = \{ \begin{matrix}x , & 0 < x \\ 0 , & x \leq 0\end{matrix} \qquad [ Equation 1 ]$$

$$Clip ( x ) = \begin{matrix}\begin{matrix}max , & max < 0\end{matrix} \\ \{ \begin{matrix}x , & min < x < max \\ min , & otherwise\end{matrix}\end{matrix} \qquad [ Equation 2 ]$$

However, the TTFS (Time to First Spike) function is an optimal activation function developed to implement the present disclosure, and may be expressed by the following equation.

$$TTFS = \begin{matrix}0 , x < {κ}^{l} ( T - {t}_{ref}^{l} ) \\ \{ \begin{matrix}{2}^{[ τ {log}_{2} ( x / {θ}_{0} ) ]} & {κ}^{l} ( T - {t}_{ref}^{l} \leq x < {θ}_{0} ) \\ {θ}_{0} , & otherwise\end{matrix}\end{matrix} \qquad [ Equation 3 ]$$

Where, ‘T’ is time, ‘κ^{l}’ is a kernel of the layer, ‘τ’ is a time constant of the layer, t^{l}_{ref} is start time of a spike, and θ₀ is a set threshold value.

A detailed description of the activation function will be described later with reference to FIGS. 3 to 5.

In the SNN generation operation (S130), the SNN model may be generated by converting parameters and weights with respect to the layer using at least one the activation function.

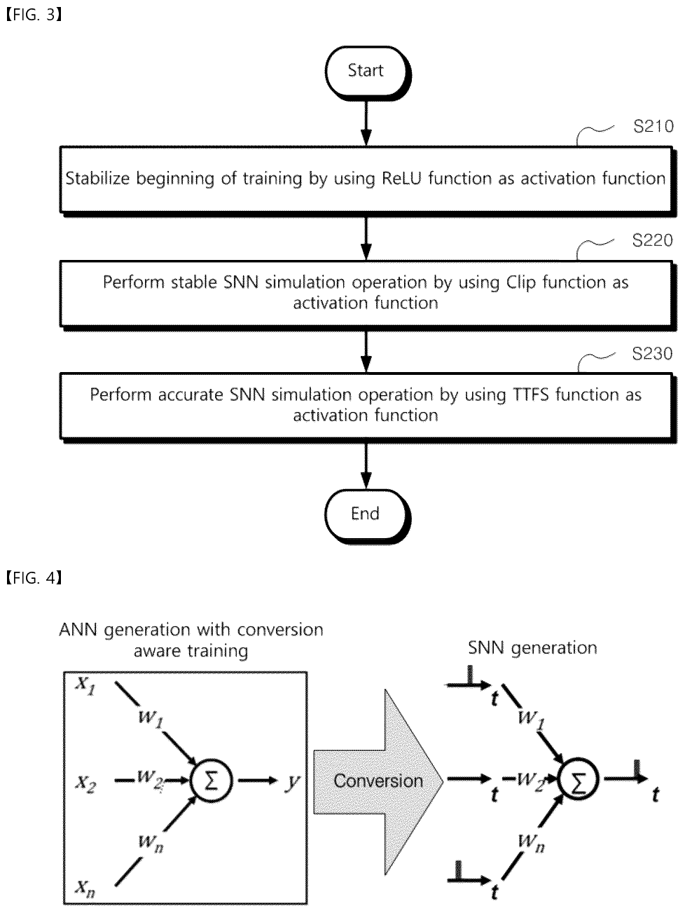

FIG. 3 is a flowchart of a conversion aware training operation, according to an embodiment of the present disclosure, and FIG. 4 is a diagram schematically illustrating a method for training a spiking neural network based on a conversion aware training according to an embodiment of the present disclosure.

In the conversion aware training operation (S120), the activation function may be used with respect to the layers of the ANN model in the order of the ReLU function, the Clip function, and the TTFS function, but is not limited thereto.

Referring to FIG. 3, stabilization at the beginning of training may be achieved by using a ReLU function as a first activation function with respect to one or more layers of the ANN model (S210).

After using the ReLU function, a stable SNN simulation operation may be performed by using the Clip function as the second activation function (S220).

After using the Clip function, an SNN simulation operation with improved accuracy may be performed using the TTFS function developed to implement the present disclosure as a third activation function (S230).

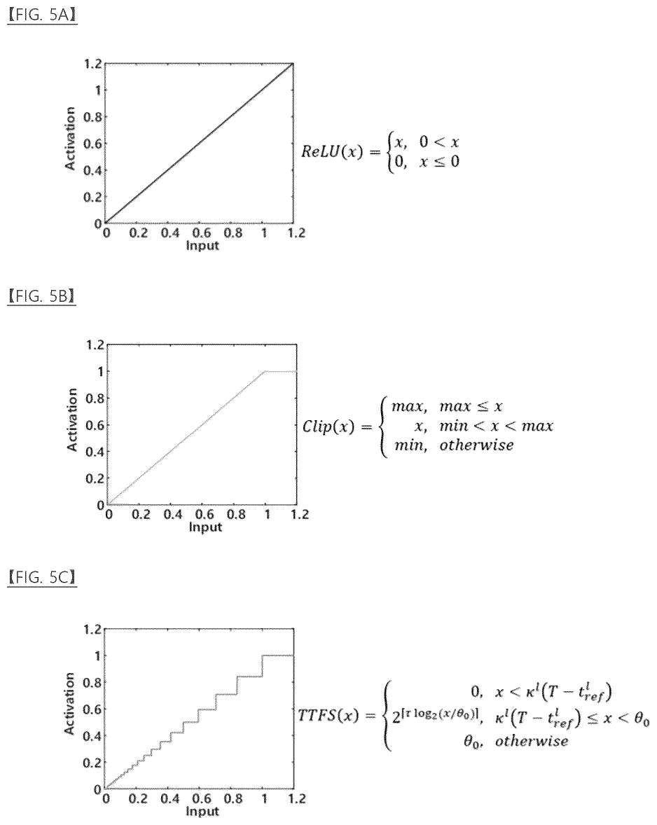

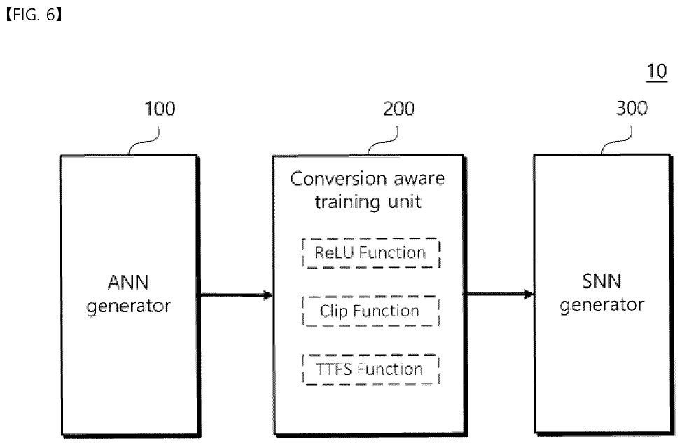

FIGS. 5A to 5C are simulation result graphs associated with a spiking neural network training method based on a conversion aware training, according to an embodiment of the present disclosure. FIG. 5A is an output graph for data input when the ReLU function is used as an activation function, and FIG. 5B is an output graph for data input when the Clip function is used as an activation function. FIG. 5C is an output graph for data input when the TTFS function is used as an activation function.

As illustrated in FIG. 5, it may be seen that the accuracy of data is improved when the activation function is used in the order of the ReLU function, the Clip function, and the TTFS function.

Examples 1 to 3 are applied to commercially available datasets, CIFAR10, CIFAR100, and Tiny-ImageNet, respectively. Table 1 is a table comparing the accuracy of the data resulting from training the datasets with respect to the ANN model.

Example 1 represents that only the Clip function is used as an activation function with respect to each layer of the ANN model, Example 2 represents that only the TTFS function is used as an activation function with respect to a first input layer of the ANN model, and Example 3 represents that the TTFS function is used as an activation function with respect to all layers of the ANN model.

TABLE 1

| Experiment | T/τ | CIFAR10 | CIFAR100 | Tiny-ImageNet |
|---|---|---|---|---|
| Example 1 | 48/8 | 92.32(−1.33) | 67.93(−4.55) | 58.75(−2.28) |
| | 24/4 | 86.99(−6.55) | 52.48(−20.23) | 49.04(−12.03) |
| | 12/2 | 62.78(−30.69) | 15.07(−57.52) | 17.19(−43.84) |
| Example 2 | 48/8 | 92.85(−0.23) | 70.62(−1.06) | 59.31(−1.61) |
| | 4/4 | 90.92(−1.80) | 64.25(−6.34) | 51.89(−8.52) |
| | 2/2 | 78.21(−12.98) | 33.93(−33.27) | 21.18(−37.88) |
| Example 3 | 48/8 | 93.18(−0.02) | 71.72(0.00) | 60.58(−0.30) |
| | 4/4 | 92.45(0.04) | 70.30(−0.13) | 59.22(−1.05) |
| | 2/2 | 90.77(−0.05) | 66.00(−0.56) | 54.99(−3.90) |

Referring to Table 1, it may be seen that the drop in accuracy of Example 3 is less than that of Examples 1 and 2. Therefore, it may be seen that the accuracy of the data is improved when the TTFS function is used as an activation function with respect to all layers of the ANN model.

Table 2 is a table comparing the performances of the prior art T2FSNN model (comparative example) and Examples 4 to 6 according to the present disclosure. In this case, the comparative example T2FSNN model indicates the conventional ANN-to-SNN conversion technique that is disclosed in the paper “T2FSNN: Deep Spiking Neural Networks with Time-to-first-spike Coding” (authors S. Park, S. Kim, B. Na and S. Yoon).

Table 2 is a table comparing the performances by applying the comparative example and Examples 4 to 6 to commercially available datasets, CIFAR10, CIFAR100, and Tiny-ImageNet, respectively.

Referring to the experimental conditions, VGG16 is used as the network, a training length is 200 epochs, an optimizer is SGD (momentum 0.9), and a training rate is 0.1 (x0.1 on epoch 80, 120, 160).

TABLE 2

| | Comparative | | | |
|---|---|---|---|---|
| | example | Example 4 | Example 5 | Example 6 |
| log function base | e | e | 2 | 2 |
| T | 80 | 80 | 48 | 24 |
| τ | 20 | 20 | 8 | 4 |
| latency | 680 | 1,360 | 816 | 408 |
| CIFAR10 | 91.43 | 93.36 | 93.18 | 92.45 |
| CIFAR100 | 68.79 | 72.14 | 71.72 | 70.30 |
| Tiny-ImageNet | — | 60.63 | 60.58 | 59.22 |

As illustrated in Table 2, in Examples 4 to 6, logarithmic base and time conditions are applied differently, and the TTFS function according to the present disclosure is used as an activation function.

When comparing the performance values of the comparative example and Examples 4 to 6, it may be seen that the performance of the present disclosure is better in all conditions. In particular, the T2FSNN model may not be applied to complex datasets such as the Tiny-ImageNet.

Therefore, according to the present disclosure, high-performance training that may be processed only by the existing ANN training model may be easily performed by using the SNN training model.

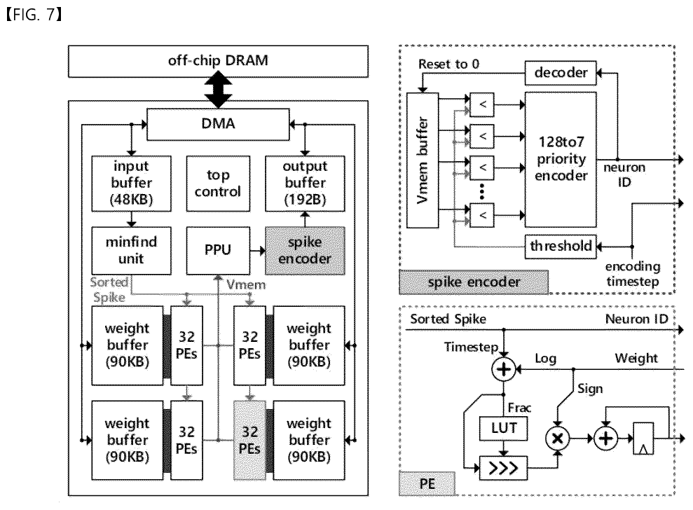

FIG. 6 is a configuration diagram of a spiking neural network training system based on a conversion aware training, according to an embodiment of the present disclosure.

Referring to FIG. 6, a spiking neural network training system 10 based a conversion aware training according to the present disclosure may include an ANN generator 100 that generates an analog artificial neural network (ANN) model and to input variable data, a conversion aware training unit 200 that simulates a spiking neural network (SNN) model by using one or more activation functions with respect to the analog ANN model, and an SNN generator 300 that generates the SNN model by correcting parameters and weights of layers based on a result of the simulation.

In this case, the conversion aware training unit 200 may use the activation functions with respect to one or more layers of the ANN model. The activation functions may include at least one of a ReLU function, a Clip function, and a Time to First Spike (TTFS) function, but is not limited thereto, and may be a function enabling SNN simulation. A detailed description of the activation functions is as described above.

In addition, in the conversion aware training unit 200, the activation functions may be used with respect to the layers of the ANN model in the order of the ReLU function, the Clip function, and the TTFS function, but is not limited thereto.

In addition, the SNN generator 300 may generate the SNN model by converting parameters and weights with respect to the layers using at least one activation function.

FIG. 7 is a block diagram of a processing device to which a spiking neural network training system based on a conversion aware training according to an embodiment of the present disclosure is applied.

Referring to FIG. 7, the processing device to which the spiking neural network training system based on the conversion aware training according to the present disclosure is applied may include four major components, that is, an input generator, a PE (Process Element) array, an output processing device, and an output control device.

The input generator includes an input buffer of 48 KB and minfind units, and merges input spikes. The PE array is composed of 128 PEs and four 90 KB weight buffers, and includes a spiking neural network training system based on conversion aware training according to the present disclosure.

The output processing device is composed of a post-processing unit (PPU) and a spike encoder, processes the output of the PE array as a spike, stores the output spike in an output buffer, and then transmits spike information to a DRAM. In addition, the output control device controls the entire processing devices, and a DMA engine manages data access with respect to an off-chip DRAM.

In this case, the input spikes are processed in an aligned manner in the input generator, and the aligned spikes are supplied to the PE array and accumulated as a membrane potential. The output of the PE array is transferred to the output processing device and is encoded into output spikes (fire operation).

Accordingly, by applying the spiking neural network training system based on conversion aware training according to the present disclosure to the processing device, data loss occurring during conversion of ANN training data into SNN training data is minimized.

Therefore, according to the present disclosure, it is possible to drive hardware with low power while performing high-performance training that can be processed only by the existing ANN training model with the SNN training model.

According to an embodiment of the present disclosure, data loss occurring during conversion of ANN training data into SNN training data may be minimized.

In addition, it is possible to drive hardware with low power while performing high-performance training that can only be processed by the existing ANN training model with the SNN training model.

The above descriptions are specific embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure. While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A method of training spiking neural network based a conversion aware training, the method comprising:
an ANN generation operation of generating an analog artificial neural network (ANN) model and inputting variable data;
a conversion aware training operation of simulating a spiking neural network (SNN) model by using one or more activation functions with respect to the analog ANN model; and
an SNN generation operation of generating the SNN model by correcting parameters and weights of layers based on a result of the simulation.

2. The method of claim 1, wherein the conversion aware training operation includes using the activation functions with respect to one or more layers of the analog ANN model.

3. The method of claim 1, wherein the activation function includes at least one or more of a ReLU function, a Clip function, and a Time to First Spike (TTFS) function.

4. The method of claim 1, wherein the activation function includes a TTFS function as in the following equation,
$$TTFS ( x ) = \begin{matrix}0 , x < {κ}^{l} ( T - {t}_{ref}^{l} ) \\ \{ \begin{matrix}{2}^{[ τ {log}_{2} ( x / {θ}_{0} ) ]} & {κ}^{l} ( T - {t}_{ref}^{l} \leq x < {θ}_{0} ) \\ {θ}_{0} , & otherwise\end{matrix}\end{matrix} , \qquad [ Equation ]$$
where ‘T’ is time, ‘κ^{l}’ is a kernel of the layer, ‘τ’ is a time constant of the layer, t^{l}_{ref} is start time of a spike, and θ₀ is a set threshold value.

5. The method of claim 1, wherein the conversion aware training operation includes using the activation functions with respect to the analog ANN model in order of a ReLU function, a Clip function, and a TTFS function.

6. The method of claim 1, wherein the SNN generation operation includes generating the SNN model by converting the parameters and the weights with respect to layers which use at least one of the activation functions.

7. A spiking neural network training system based a conversion aware training comprising:
an ANN generator configured to generate an analog artificial neural network (ANN) model and to input variable data;
a conversion aware training unit configured to simulate a spiking neural network (SNN) model by using one or more activation functions with respect to the analog ANN model; and
an SNN generator configured to generate the SNN model by correcting parameters and weights of layers based on a result of the simulation.

8. The spiking neural network training system based the conversion aware training of claim 7, wherein the conversion aware training unit uses the activation functions with respect to one or more layers of the analog ANN model.

9. The spiking neural network training system based the conversion aware training of claim 7, wherein the activation function includes at least one or more of a ReLU function, a Clip function, and a Time to First Spike (TTFS) function.

10. The spiking neural network training system based the conversion aware training of claim 7, wherein the activation function includes a TTFS function as in the following equation,
$$TTFS ( x ) = \begin{matrix}0 , x < {κ}^{l} ( T - {t}_{ref}^{l} ) \\ \{ \begin{matrix}{2}^{[ τ {log}_{2} ( x / {θ}_{0} ) ]} & {κ}^{l} ( T - {t}_{ref}^{l} \leq x < {θ}_{0} ) \\ {θ}_{0} , & otherwise\end{matrix}\end{matrix} , \qquad [ Equation ]$$
where ‘T’ is time, ‘κ^{l}’ is a kernel of the layer, ‘τ’ is a time constant of the layer, t^{l}_{ref} is start time of a spike, and θ₀ is a set threshold value.

11. The spiking neural network training system based the conversion aware training of claim 7, wherein the conversion aware training unit applies the activation functions to the analog ANN model in order of a ReLU function, a Clip function, and a TTFS function.

12. The spiking neural network training system based the conversion aware training of claim 7, wherein the SNN generator generates the SNN model by converting the parameters and the weights with respect to layers which use at least one of the activation functions.
